(19) United States
(12) Patent Application Publication
(10) Pub. No.: US 2012/0031220 A1
(43) Pub. Date: Feb. 9, 2012

(54) PEDAL DEVICE FOR VEHICLE

(76) Inventor: Tomohiro Seki, Hamamatsu-shi (JP)

(21) Appl. No.: 13/184,786

(22) Filed: Jul. 18, 2011

(30) Foreign Application Priority Data
Aug. 6, 2010 (JP) 2010-176873

(51) Int. Cl. B60T 7/06

(52) U.S. Cl. 74/512

(57) ABSTRACT

In a brake pedal device 1 of a vehicle, including a pedal retreat suppression mechanism for turning a pedal arm 2 to the vehicle front in association with the operation of a dash panel 7 moving to the vehicle rear on receipt of a shock load applied from the vehicle front, the pedal retreat suppression mechanism includes a link mechanism 16 and a trigger 15 attached turnably to a pedal bracket 8 so that a second link 19 of the link mechanism 16 is disengaged from a pedal shaft 3 by the trigger 15 moving to the vehicle rear on receipt of a shock load applied from the vehicle front, an intermediate portion of a first link 18 of the link mechanism 16 is pivotally supported on the pedal arm 2, and a push rod 9a is connected to the lower end portion of the first link 18.

### CROSS-RELATED APPLICATIONS

This application claims priority from Japanese Patent Application No. 2010-176873; filed Aug. 6, 2010, the disclosure of which is incorporated herein by reference in its entirety.

### BACKGROUND OF THE INVENTION

The present invention relates to a pedal device of a vehicle, which is provided with a pedal retreat suppression mechanism that turns a pedal arm to the vehicle front in association with the operation of a dash panel moving to the vehicle rear on receipt of a shock load applied from the vehicle front.

A brake pedal device and a clutch pedal device of a vehicle each have a pedal arm the upper end portion of which is pivotally supported on a pedal bracket attached to a dash panel. By depressing a pedal of the pedal arm, the driver performs a required braking or speed-changing operation by transmitting the displacement of the pedal to a brake master cylinder or a clutch master cylinder.

The master cylinder is directly mounted to the dash panel. Therefore, there arises a problem that if the dash panel is moved to the vehicle rear by a large shock load applied from the vehicle front, the master cylinder mounted to the dash panel also moves to the vehicle rear, and the push rod thereof turns the pedal atm to the vehicle rear.

Accordingly, there has been proposed a pedal retreat suppression mechanism that turns the pedal arm to the vehicle front in association with the operation of the dash panel moving to the vehicle rear on receipt of a shock load applied from the vehicle front (for example, refer to Patent Documents 1 to 4). Hereunder, one example of the pedal retreat suppression mechanism is explained with reference to FIGS. 5 and 6.

FIGS. 5 and 6 are views showing the pedal retreat suppression mechanism provided on the brake pedal. FIG. 5 shows a normal state, and FIG. 6 shows the state in which a shock load is applied from the vehicle front. In FIGS. 5 and 6, (a) is a side view, and (b) is a perspective view.

For a pedal arm 102 of a brake pedal device 101 shown in FIGS. 5 and 6, the upper end thereof is pivotally supported on a pedal bracket 108 by a pedal shaft 103 so that the pedal arm 102 can be turned in the front-and-rear direction of vehicle. The pedal bracket 108 is attached to a dash panel, not shown, and in the rear of the pedal bracket 108, a vehicle body frame 130 such as a steering support member is disposed.

The pedal retreat suppression mechanism is configured so as to include a link mechanism 116 connecting the pedal arm 102 to the pedal shaft 103 and a trigger 115 turnably supported on the pedal bracket 108. The link mechanism 116 consists of a first link 118 and a second link 119 connected to each other by a pin 117. The lower end of the first link 118 is turnably connected to an intermediate portion of the pedal arm 102 by a shaft 120. Also, at the upper end of the second link 119, a hook-form engagement part 119a cut into a semicircular shape is formed. At the normal time shown in FIG. 5, the engagement part 119a engages with the outer periphery of the pedal shaft 103.

To the dash panel, not shown, a brake master cylinder 109 is mounted. The end portion of a push rod 109a extending from the brake master cylinder 109 toward the vehicle rear is connected to an intermediate portion of the first link 118. Also, on the outer periphery of the pedal shaft 103, a return spring 124 is wound. One end of the return spring 124 is locked to the pedal bracket 108, and the other end thereof is locked to the second link 119. That is, the return spring 124 is configured so that the looseness of the link mechanism 116 is absorbed by the urging of the second link 119 caused by the return spring 124.

For the trigger 115, one end thereof is turnably attached to the pedal bracket 108 by a shaft 129. The trigger 115 is formed with a contact piece 115a extending to the vehicle front, and at the normal time, the contact piece 115a is located in the rear of the second link 119 with a predetermined gap being provided therebetween as shown in FIG. 5.

In the brake pedal device 101 having the pedal retreat suppression mechanism configured as described above, at the normal time shown in FIG. 5, when the driver depresses a pedal 105 attached to the lower end of the pedal arm 102, the pedal arm 102 turns to the vehicle front with the pedal shaft 103 being the center, and the turn of the pedal arm 102 is transmitted to the push rod 109a via the link mechanism 116. Thereby, the push rod 109a is pushed in, and the brake master cylinder 109 is driven, whereby required braking is accomplished.

When the vehicle receives a large shock load from the front, the dash panel moves to the vehicle rear together with the pedal bracket 108 and the brake master cylinder 109 mounted thereto. Therefore, as shown in FIG. 6, the trigger 115 attached to the pedal bracket 108 also moves to the vehicle rear, and the back surface portion thereof comes into contact with the front end portion of the vehicle body frame 130. Then, the trigger 115 turns in the counterclockwise direction (the arrow-marked direction in FIG. 6(a)) with the shaft 129 being the center, and the contact piece 115a at the front end thereof presses an intermediate portion of the second link 119 to the vehicle front. Therefore, the engagement part 119a of the second link 119 comes off the pedal shaft 103 and becomes free.

When the engagement part 119a of the second link 119 comes off the pedal shaft 103 and becomes free as described above, the second link 119 is turned in the clockwise direction (the arrow-marked direction in FIG. 6(a)) by the urging force of the return spring 124, and the push rod 109a pushes the first link 118 in, whereby the first link 118 is turned in the counterclockwise direction, and the pedal arm 102 is turned to the vehicle front with the pedal shaft 103 being the center. Therefore, the pedal arm 102 retracts from the position indicated by a chain line in FIG. 6(a) to the position indicated by a solid line therein.

In the conventional pedal retreat suppression mechanism shown in FIGS. 5 and 6, when the vehicle receives a large shock load from the front, as shown in FIG. 6, the second link 119 is turned in the clockwise direction (the arrow-marked direction in FIG. 6(a)) by the urging force of the return spring 124, and the push rod 109a pushes the first link 118 in, whereby the first link 118 is turned in the counterclockwise direction. Therefore, the first link 118 may interfere with a part such as a steering column arranged in the rear thereof. In the case in which the turn of the first link 118 is hindered by the interference, there is a fear that the pedal retreat suppression mechanism does not function normally. In order to overcome this fear, it is necessary to offset the first link 118 from the part such as the steering column to avoid the arrangement of the part such as the steering column in the rear of the first link 118, or to provide a sufficient space between the first link 118 and the part such as the steering column, which poses a problem that the layout is restricted.

### SUMMARY OF THE INVENTION

The present invention has been made to solve the above problem, and accordingly an object thereof is to provide a pedal device of a vehicle, in which the layout is not restricted, and a pedal retreat suppression mechanism can be operated reliably when the vehicle receives a large shock load from the front.

To achieve the above object, the first aspect of the invention provides a pedal device of a vehicle, includes a pedal arm the upper end portion of which is pivotally supported, by a pedal shaft, on a pedal bracket attached to a dash panel; a link mechanism for transmitting the turning motion of the pedal arm to a push rod of a master cylinder; and a pedal retreat suppression mechanism for turning the pedal arm to the vehicle front in association with the operation of the dash panel moving to the vehicle rear on receipt of a shock load applied from the vehicle front, the link mechanism being configured so as to include a first link pivotally supported on the pedal arm and a second link one end of which is connected to the first link and the other end of which engages detachably with the pedal shaft; the push rod being connected to the first link; and the pedal retreat suppression mechanism being configured so as to include the link mechanism and a trigger attached turnably to the pedal bracket so that the second link is disengaged from the pedal shaft by the trigger moving to the vehicle rear on receipt of a shock load applied from the vehicle front, wherein an intermediate portion of the first link of the link mechanism is pivotally supported on the pedal arm, and the push rod is connected to the lower end portion of the first link.

The second aspect of the invention is characterized in that, in the first aspect of the invention, the front end portion of a steering column is arranged in the vehicle rear of the first link of the link mechanism.

The third aspect of the invention is characterized in that, in the second aspect of the invention, in the state in which one end of the second link of the link mechanism engages with the pedal shaft, the turn of the first link is inhibited, the connection point of the first link and the second link is located between the intermediate portion of the first link and the pedal shaft in the up-and-down direction, and the front end portion of the steering column is located between the intermediate portion of the first link and the pedal shaft in the up-and-down direction.

According to the first aspect of the invention, since the intermediate portion of the first link of the link mechanism is pivotally supported on the pedal arm, and the push rod is connected to the lower end portion of the first link, when the vehicle receives a large shock load from the front, the first link turns to the direction such as to depart from a part such as the steering column arranged in the rear of the first link (to the vehicle front), so that the turn of the first link is not hindered by the part such as the steering column, and the pedal retreat suppression mechanism operates reliably to suppress the retreat of the pedal arm. Therefore, it is unnecessary to offset the first link from the part such as the steering column to avoid the arrangement of the part such as the steering column in the rear of the first link, or to provide a sufficient space between the first link and the part such as the steering column, and therefore the layout of various parts is not restricted.

According to the second aspect of the invention, since the front end portion of the steering column is arranged in the vehicle rear of the first link of the link mechanism, when the vehicle receives a large shock load from the front, even if the first link of the link mechanism moving to the vehicle rear together with the dash panel comes into contact with the front end portion of the steering column that scarcely moves, the first link is turned to the operation direction (the direction in which the pedal retreat suppression mechanism operates) by the steering column, and the pedal retreat suppression mechanism operates more reliably to suppress the retreat of the pedal arm.

According to the third aspect of the invention, since the connection point of the first link and the second link constituting the link mechanism is arranged between the intermediate portion (the portion in which the first link is pivotally supported on the pedal arm) of the first link and the pedal shaft in the up-and-down direction, and the front end portion of the steering column is arranged between the intermediate portion of the first link and the pedal shaft in the up-and-down direction, when the vehicle receives a large shock load from the front, the first link turns reliably to the direction such as to depart from the part such as the steering column arranged in the rear of the first link (to the vehicle front), so that the turn of the first link is not hindered by the part such as the steering column.

### BRIEF DESCRIPTION OF THE DRAWINGS

FIG. 1 is an exploded perspective view of a brake pedal device in accordance with the present invention;

FIG. 2 is a partially broken side view showing a state of a brake pedal device in accordance with the present invention at the normal time;

FIG. 3 is a front view showing a state of a brake pedal device in accordance with the present invention at the normal time;

FIG. 4 is a partially broken side view showing a state in which a shock load is applied to a brake pedal device in accordance with the present invention from the vehicle front;

FIG. 5(a) is a side view showing a state of a conventional brake pedal device at the normal time, and FIG. 5(b) is a perspective view showing the same state; and

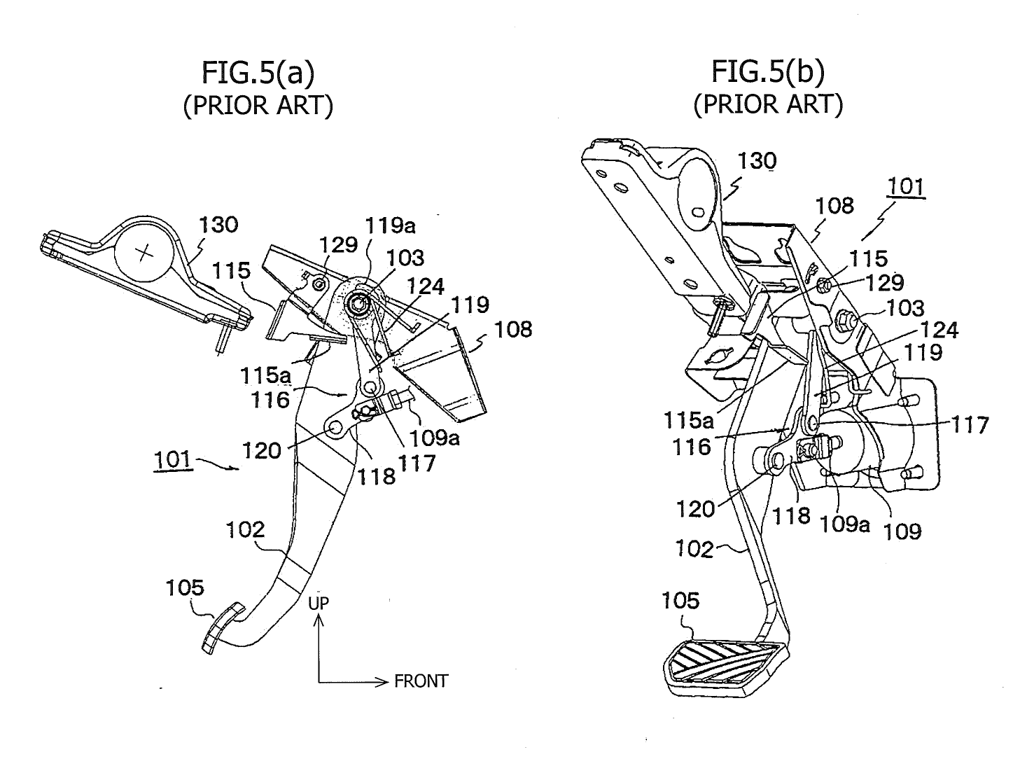

FIG. 6(a) is a side view showing a state in which a shock load is applied to a conventional brake pedal device from the vehicle front, and FIG. 6(b) is a perspective view showing the same state.

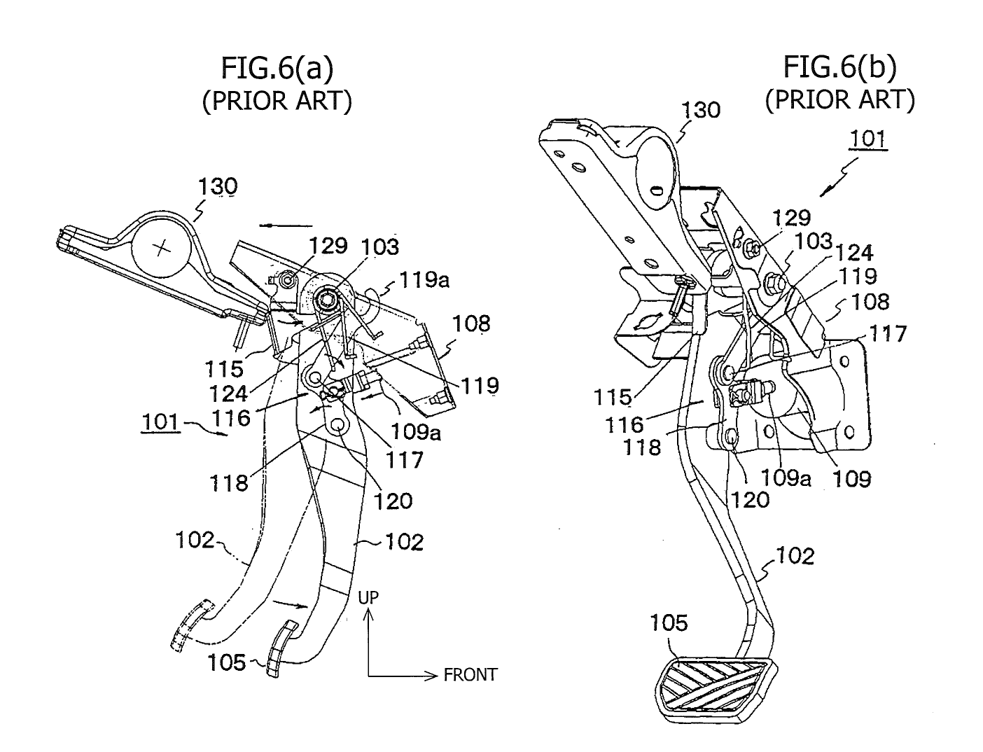

### DETAILED DESCRIPTION OF PREFERRED EMBODIMENTS

The present invention now will be described more fully hereinafter in which embodiments of the invention are provided with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs.

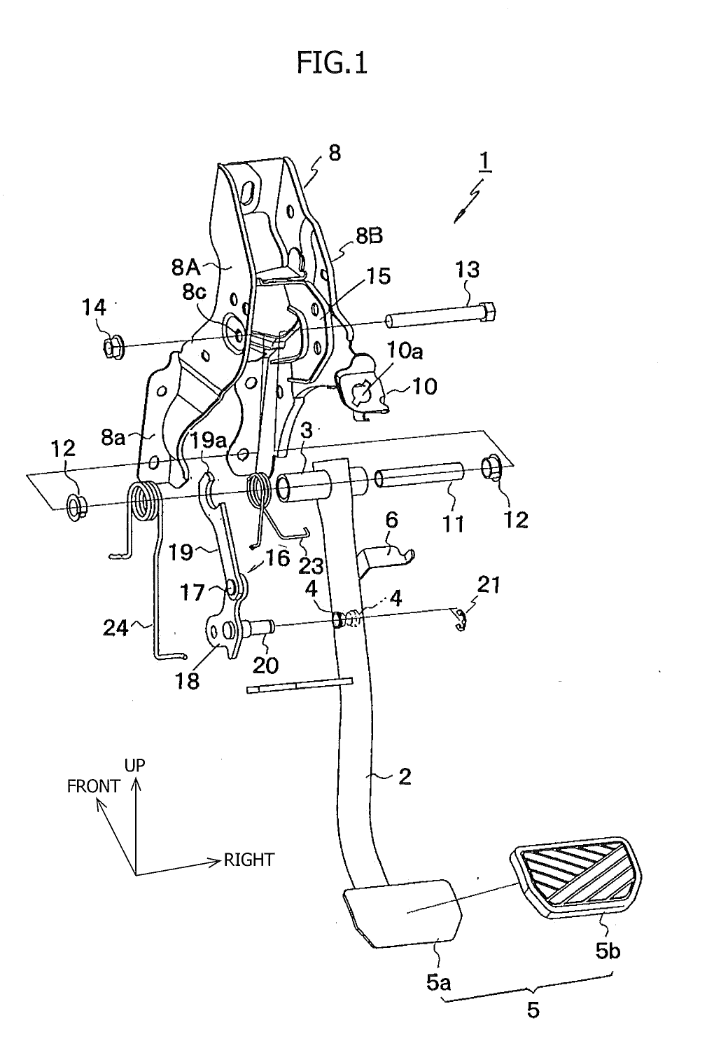

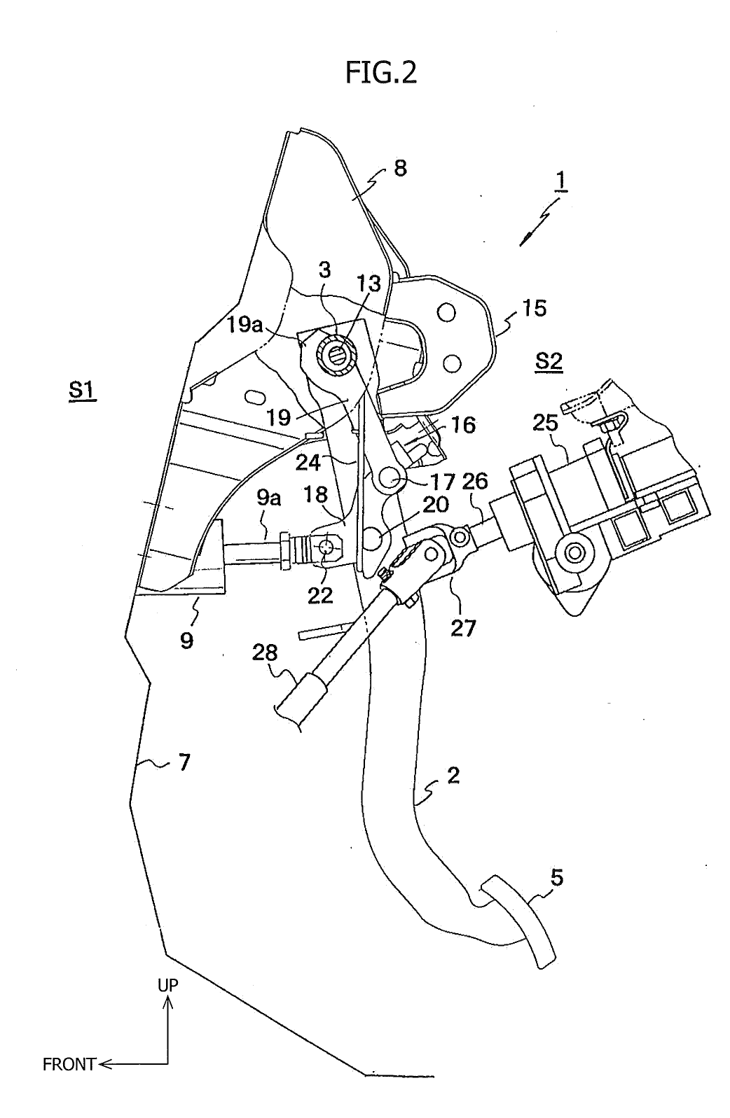

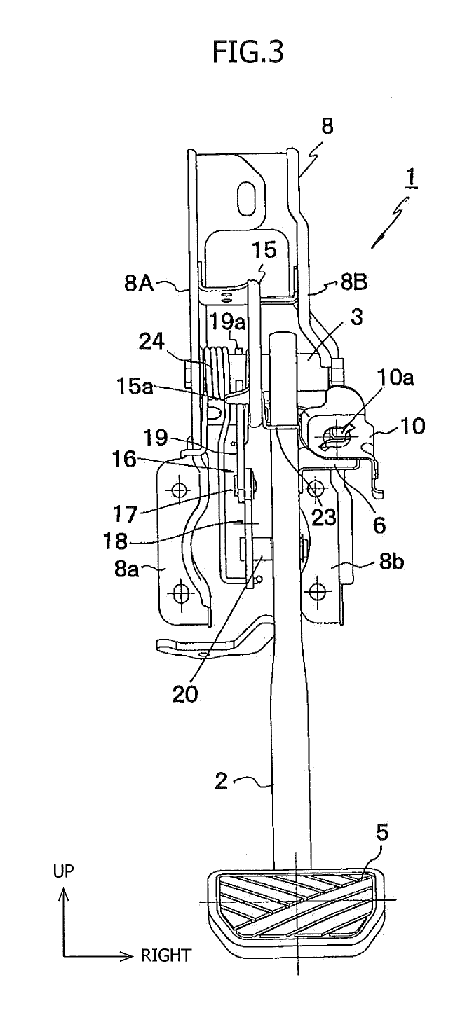

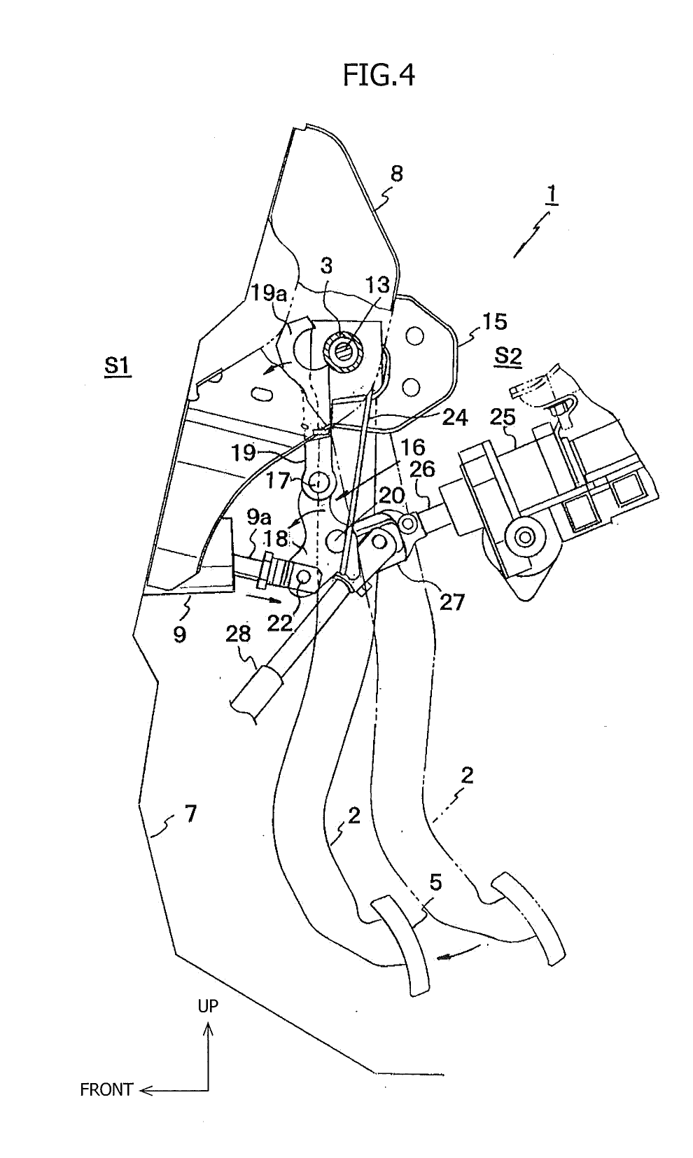

FIG. 1 is an exploded perspective view of a brake pedal device in accordance with the embodiment of the present invention, FIG. 2 is a partially broken side view showing the state of the brake pedal device at the normal time, FIG. 3 is a front view showing the state of the brake pedal device at the normal time, and FIG. 4 is a partially broken side view showing the state in which a shock load is applied to the brake pedal device from the vehicle front.

A brake pedal device 1 shown in the figures includes a pedal arm 2. The pedal arm 2 is formed of a pipe material. To the upper end portion of the pedal arm 2, a cylindrical pedal shaft 3 is insertedly fixed in the transverse direction as shown in FIG. 1, and in an intermediate portion thereof, a circular hole, not shown, is penetratingly provided in the transverse direction. In the right and left opening portions of this circular hole, bushes 4 are fitted. Also, to the lower end portion of the pedal arm 2, a pedal 5 depressed by the driver's foot is attached. On the right-hand side under the pedal shaft 3 of the pedal arm 2, a sheet metal-made pressing member 6 is attached to transmit the operation of the pedal arm 2 and to pressingly operate a brake lamp switch. As shown in FIG. 1, the pedal 5 is configured by bonding a rubber-made pedal pad 5b onto a substantially rectangular metal plate 5a connected to the lower end of the pedal arm 2.

As shown in FIG. 2, to a dash panel 7 partitioning a vehicle compartment S2 from an engine room S1 of the vehicle, a pedal bracket 8 and a brake master cylinder 9 (only a portion existing in the vehicle compartment S2 is shown) are mounted. The pedal bracket 8, which is a sheet metal-made member, is attached to the surface on the vehicle compartment S2 side of the dash panel 7 by fastening flanges 8a and 8b of the left and right side walls 8A and 8B disposed in the vehicle width direction to the surface of the dash panel 7 with bolts, not shown.

As shown in FIG. 1, at the opposed positions on the left and right side walls 8A and 8B of the pedal bracket 8, bolt insertion holes 8c (only one of these holes is shown in FIG. 1) are formed. The right side wall 8B is formed with a bracket 10. In a circular engagement hole 10a formed in the bracket 10, the brake lamp switch, not shown, is fixedly fitted to light a brake lamp of the vehicle by sensing the movement of the pedal arm 2 by using the pressing member 6.

The upper end portion of the pedal arm 2 is supported on the pedal bracket 8 so as to be turnable in the front-and-rear direction of the vehicle by the mounting structure described below.

As shown in FIG. 1, in the pedal shaft 3 insertedly fixed in the transverse direction to the upper end portion of the pedal arm 2, a cylindrical collar 11 is inserted through, and on the outer peripheries in both end portions in the axial direction of the collar 11, bushes 12 for reducing sliding resistance and for positioning are fitted. While this state is maintained, the upper end portion of the pedal arm 2 is fitted in between the left and right side walls 8A and 8B of the pedal bracket 8, a bolt 13 that is inserted from the right-hand side into the bolt insertion hole 8c formed in the right side wall 8B of the pedal bracket 8 is inserted through the collar 11, and a nut 14 that threadedly engages with the threaded portion of the bolt 13 projecting to the left-hand side from the bolt insertion hole 8c formed in the left side wall 8A of the pedal bracket 8 is tightened, whereby the upper end portion of the pedal arm 2 is attached to the pedal bracket 8 so as to be turnable in the front-and-rear direction of vehicle with the bolt 13 being the center.

The brake pedal device 1 in accordance with this embodiment is provided with a pedal retreat suppression mechanism for suppressing the rearward movement of the pedal arm 2 by turning the pedal aim 2 to the vehicle front when the vehicle receives a strong shock from the front. This pedal retreat suppression mechanism is configured so as to include a trigger 15 attached to the pedal bracket 8 and a link mechanism 16 that connects the pedal arm 2 to the pedal shaft 3 and the brake master cylinder 9.

The link mechanism 16 is arranged in the left-hand side portion of the pedal arm 2, and is formed by a first link 18 and a second link 19 that are connected to each other by a pin 17. At the upper end of the second link 19, a hook-form engagement part 19a (refer to FIG. 1) cut into a semicircular shape open to the rear is formed. At the normal time shown in FIGS. 2 and 3 (when a strong shock is not applied from the vehicle front), the engagement part 19a engages with the outer periphery of the pedal shaft 3 from the front side of vehicle. The lower end of the second link 19 is connected to the upper end of the first link 18 by the pin 17. Also, the intermediate portion of the first link 18 is turnably connected to the pedal arm 2 by inserting a shaft 20 projectingly provided in the transverse direction in the intermediate portion of the first link 18 into the right and left bushes 4 and a circular hole, not shown, formed in the pedal arm 2 and by locking snap ring 21 to the end portion of the shaft 20.

The trigger 15 is a flat member formed into a U shape in side view by press molding a sheet metal, and is disposed between the left and right side walls 8A and 8B of the pedal bracket 8 as shown in FIG. 3. At the normal time shown in FIGS. 2 and 3, a contact piece 15a projectingly provided in the transverse direction (the right-and-left direction of vehicle) in the tip end portion of the trigger 15 and formed so as to have a wide width is located in the rear of the second link 19 in the state in which a predetermined gap is provided between the contact piece 15a and the second link 19.

From the brake master cylinder 9 mounted to the dash panel 7, a push rod 9a extends toward the vehicle rear. The rear end of the push rod 9a is connected to the lower end portion of the first link 18 by a pin 22. As shown in FIG. 2, the connection point at which the first link 18 and the second link 19 constituting the link mechanism 16 are connected to each other by the pin 17 is located between the shaft 20 in the intermediate portion of the first link 18 and the pedal shaft 3 in the up-and-down direction. More specifically, as shown in FIG. 2, the shafts are arranged in the order of the pin 22, the shaft 20, the pin 17, and the engagement part 19a (the pedal shaft 3) from the downside, the pin 22 is arranged on the vehicle front side of the shaft 20, and the pin 17 is arranged on the vehicle rear side of the line connecting the shaft 20 to the pedal shaft 3.

Also, on the periphery of the pedal shaft 3, two springs 23 and 24 consisting of coil springs are wound. As shown in FIGS. 2 and 3, one end of the one spring 23 is locked to the pedal arm 2, and the other end thereof is locked to the second link 19. Therefore, by the spring 23, the second link 19 is urged to the direction in which the engagement part 19a engages with the pedal shaft 3 and the position of the pin 17 is further located on the vehicle rear side, whereby the looseness of the link mechanism 16 is absorbed. One end of the other spring 24 is locked to a position lower than the shaft 20 of the first link 18, and the other end thereof is locked to the left side wall 8A of the pedal bracket 8. Therefore, by the spring 24, the pedal arm 2 is urged in the counterclockwise direction in FIG. 2 with the pedal shaft 3 (the bolt 13) being the center, and the first link 18 is urged so as to be turned in the counterclockwise direction in FIG. 2 with respect to the shaft 20. Against the rotation in the counterclockwise direction in FIG. 2 caused by the urging force of the spring 24 and the reaction force received from the push rod 9a, the second link 19 engaging with the pedal shaft 3 regulates the movement.

As shown in FIG. 2, in the vehicle compartment S2, a steering column 25 is disposed by being attached to a steering support member in a state of tilting to the slantwise downside toward the front, and a rotatable steering shaft 26 is insertedly supported in the steering column 25. The upper end (rear end) of the steering shaft 26 is connected with a steering wheel, not shown, and the lower end (front end) thereof is connected with the upper end of an intermediate shaft 28 via a universal joint 27. The intermediate shaft 28 is arranged on the left-hand side of the pedal arm 2, and although not shown in the figures, the lower end of the intermediate shaft 28 is connected to a steering gear box.

At the normal time shown in FIGS. 2 and 3 (when the vehicle does not receive a large shock load from the front), as described above, the contact piece 15a projectingly provided in the transverse direction at the lower end of the trigger 15 is located in the rear of the second link 19 in the state in which the predetermined gap is provided between the contact piece 15a and the second link 19. Also, the front end portion (the universal joint 27 and the like) of the steering column 25 is located between the intermediate portion of the first link 18 and the pedal shaft 3 in the up-and-down direction. More specifically, the front end portion of the steering column 25 is located between the shaft 20 of the first link 18 and the pedal shaft 3, and the universal joint 27 is arranged at almost the same height as that of the shaft 20 of the first link 18.

Next, the operation of the brake pedal device 1 having the pedal retreat suppression mechanism configured as described above is explained.

At the normal time shown in FIGS. 2 and 3, as shown in the figures, the engagement part 19a of the second link 19 engages with the pedal shaft 3, so that the second link 19 and the first link 18 are inhibited from turning. When the driver depresses, using the driver's foot, the pedal 5 attached to the lower end of the pedal arm 2, the pedal arm 2 turns to the vehicle front with the pedal shaft 3 (the bolt 13) being the center. This turn of the pedal arm 2 is transmitted to the push rod 9a by the link mechanism 16, and the push rod 9a moves linearly and is pushed in. Therefore, the brake master cylinder 9 is driven, and a braking force required for the vehicle is generated, whereby the vehicle is stopped or decelerated.

When the vehicle receives a large shock load from the front, the dash panel 7 moves to the vehicle rear together with the pedal bracket 8 and the brake master cylinder 9 mounted thereto. Therefore, the trigger 15 attached to the pedal bracket 8 also moves integrally to the vehicle rear, and the trigger 15 comes into contact with a part on the vehicle body side (for example, the steering support member). Then, as shown in FIG. 4, the contact piece 15a projectingly provided at the lower end of the trigger 15 comes into contact with an intermediate portion of the second link 19 of the link mechanism 16 and presses it. Therefore, the engagement part 19a at the upper end of the second link 19 comes off the pedal shaft 3 and becomes free.

When the engagement part 19a of the second link 19 comes off the pedal shaft 3 and becomes free as described above, by the urging force of the spring 24, the first link 18 is turned in the arrow-marked direction in FIG. 4 (the counterclockwise direction) with the shaft 20 being the turning center. Also, because the push rod 9a pushes the first link 18 in to the vehicle rear, the first link 18 turns in the arrow-marked direction in FIG. 4 (the counterclockwise direction) with the shaft 20 being the turning center. Thereby, the position of the pin 22 connecting the rear end of the push rod 9a to the lower end portion of the first link 18 and the position of the shaft 20 of the first link 18 are reversed, and the pedal arm 2 is turned to the vehicle front with the pedal shaft 3 (the bolt 13) being the center. Therefore, the pedal arm 2 turns to the vehicle front with the pedal shaft 3 (the bolt 13) being the center, and turns and retracts from the position indicated by a chain line in FIG. 4 to the position indicated by a solid line therein, so that the retreat of the pedal arm 2 is suppressed reliably. In FIG. 4, to illustrate the state of the first link 18, the universal joint 27 and the intermediate shaft 28 are shown broken.

As described above, in this embodiment, the intermediate portion of the first link 18 of the link mechanism 16 is pivotally supported on the pedal arm 2 by the shaft 20, and the push rod 9a is connected to the lower end portion of the first link 18. Therefore, when the vehicle receives a large shock load from the front, as shown in FIG. 4, the upper portion of the first link 18 turns to the direction such as to depart from the part such as the steering column 25 arranged in the rear of the first link 18 (to the vehicle front), so that the turn of the first link 18 is not hindered by the part such as the steering column 25, and the pedal retreat suppression mechanism operates reliably to suppress the retreat of the pedal arm 2. As a result, it is unnecessary to offset the first link 18 from the part such as the steering column 25 to avoid the arrangement of the part such as the steering column 25 in the rear of the first link 18, or to provide a sufficient space between the first link 18 and the part such as the steering column 25, and therefore the layout of various parts is not restricted.

Also, in this embodiment, the front end portion (the universal joint 27) of the steering column 25 is arranged in the vehicle rear of the first link 18 of the link mechanism 16. Therefore, when the vehicle receives a large shock load from the front, even if the upper portion of the first link 18 of the link mechanism 16 moving to the vehicle rear together with the dash panel 7 comes into contact with the front end portion (the universal joint 27) of the steering column 25 that scarcely moves, the first link 18 is turned to the operation direction (the direction in which the pedal retreat suppression mechanism operates) by the steering column 25, and the pedal retreat suppression mechanism operates more reliably to suppress the retreat of the pedal arm 2.

Furthermore, in this embodiment, the connection point at which the first link 18 and the second link 19 constituting the link mechanism 16 are connected to each other by the pin 17 is located between the intermediate portion of the first link 18 (the portion in which the first link 18 is pivotally supported on the pedal arm 2 by the pin 20) and the pedal shaft 3 in the up-and-down direction, and the front end portion (the universal joint 27) of the steering column 25 is arranged between the intermediate portion (the shaft 20) of the first link 18 and the pedal shaft 3 in the up-and-down direction. Therefore, when the vehicle receives a large shock load from the front, the first link 18 turns reliably to the direction such as to depart from the part such as the steering column 25 arranged in the rear of the first link 18 (to the vehicle front), so that there is achieved an effect that the turn of the first link 18 is not hindered by the part such as the steering column 25, and the pedal retreat suppression mechanism operates reliably.

The above is a description of a mode in which the present invention is applied to the brake pedal device. Of course, the present invention can also be applied similarly to a clutch pedal device.

Having thus described certain embodiments of the present invention, it is to be understood that the invention defined by the appended claims is not to be limited by particular details set forth in the above description as many apparent variations thereof. are possible without departing from the spirit or scope thereof as hereinafter claimed. The following claims are provided to ensure that the present application meets all statutory requirements as a priority application in all jurisdictions and shall not be construed as setting forth the full scope of the present invention.

What is claimed is:

1. A pedal device for a vehicle, comprising:
a pedal arm the upper end portion of which is pivotally supported, by a pedal shaft, on a pedal bracket attached to a dash panel;
a link mechanism for transmitting the turning motion of the pedal arm to a push rod of a master cylinder; and
a pedal retreat suppression mechanism for turning the pedal arm to the vehicle front in association with the operation of the dash panel moving to the vehicle rear on receipt of a shock load applied from the vehicle front,
the link mechanism being configured so as to include a first link pivotally supported on the pedal arm and a second link one end of which is connected to the first link and the other end of which engages detachably with the pedal shaft;
the push rod being connected to the first link; and
the pedal retreat suppression mechanism being configured so as to include the link mechanism and a trigger attached turnably to the pedal bracket so that the second link is disengaged from the pedal shaft by the trigger moving to the vehicle rear on receipt of a shock load applied from the vehicle front,
wherein an intermediate portion of the first link of the link mechanism is pivotally supported on the pedal arm, and the push rod is connected to the lower end portion of the first link.

2. The pedal device of a vehicle according to claim 1, wherein the front end portion of a steering column is arranged in the vehicle rear of the first link of the link mechanism.

3. The pedal device of a vehicle according to claim 2, wherein in a state in which one end of the second link of the link mechanism engages with the pedal shaft, the turn of the first link is inhibited, the connection point of the first link and the second link is located between the intermediate portion of the first link and the pedal shaft in the up-and-down direction, and the front end portion of the steering column is located between the intermediate portion of the first link and the pedal shaft in the up-and-down direction.
